(19) United States
(12) Patent Application Publication
(10) Pub. No.: US 2010/0311319 A1
(43) Pub. Date: Dec. 9, 2010

(54) ROOF VENT

(75) Inventors: James H.A. McKee, Midhurst (CA); James Mantyla, Barrie (CA)

Correspondence Address: HOFFMANN & BARON, LLP, 6900 JERICHO TURNPIKE, SYOSSET, NY, 11791, US

(73) Assignee: CANPLAS INDUSTRIES LTD., Barrie (CA)

(21) Appl. No.: 12/856,841

(22) Filed: Aug. 16, 2010

Related U.S. Application Data
(63) Continuation of application No. 11/705,619, filed on Feb. 13, 2007, now Pat. No. 7,774,999.

(30) Foreign Application Priority Data
Feb. 13, 2006 (CA) 2536023

(51) Int. Cl. F24F 7/02; B23P 11/00

(52) U.S. Cl. 454/365; 29/525.01

(57) ABSTRACT

A roof vent is provide. The roof vent comprises a top component coupled to a bottom component. The top component has a top wall, a side wall, a first louvered region disposed between said top wall and said side wall, and a top cylindrical baffle located inwardly of said first louvered region. The bottom component has at least a first cylindrical collar sized and shaped for mounting to a cylindrical exhaust stack of a first diameter, a second louvered region, and a bottom cylindrical baffle located below and inwardly of the top cylindrical baffle. The first louvered and second louvered regions are for helping to prevent insects, and moisture, such as snow and rain, from entering the roof vent. The top component may also be used separately from the bottom component to cover over aging or aesthetically unpleasing passive pot vents.

### FIELD OF THE INVENTION

This invention relates generally to building products and in particular to ventilation devices which are used in buildings to provide for the circulation of air between an exterior and an interior or closed in portion of the building. Most particularly this invention relates to vents that are used to permit ventilation of attics or other spaces under a roofed area and which are referred to as passive roof vents.

### BACKGROUND OF THE INVENTION

As is well known, if a building is warm inside and cold outside, and there is sufficient humidity within the building, this humidity will condense on contact with the cold surface of the building. This is usually most noticeable at the roof. Such condensed humidity or moisture will eventually cause the wood and other roof material to rot. Thus preventative measures are typically necessary to prevent such condensation from occurring. One such measure is to adequately ventilate all parts of the building where condensation is likely to occur.

Apart from the condensation problem mentioned above, there also exists the basic ventilation problem of removing stale air from enclosed spaces, and replacing it with fresh outside air. Roof mounted ventilation devices can also be used for this purpose.

Accordingly, there have been numerous examples proposed in the past of roof mounted structures to provide suitable ventilation for various ventilation purposes.

One such device is known as a Turbine Ventilator and is described in U.S. Pat. No. 3,267,833 to Artis et al. This invention provides a free flow roof turbine or ventilator, which have since become commonly utilized to inexpensively exhaust dormant hot air from attics or other space under a roofed area. They are also used to evacuate warm air from such areas as kitchens or laundries.

Turbine ventilators are generally constructed of a plurality of curvilinear blades supported in a freely rotatable frame. The blades are contoured and oriented in relation to one another such that warm air rising from below, passes through the blades and due to the blade orientation, urges the blades and consequently the frame to rotate and expel the warm air.

One of the disadvantages of the prior art turbine vent devices is that they require a minimum of two to four separate and distinct members or pieces which are relatively expensive to manufacture and which necessitate a relatively complicated process to construct together to form the desired vent apparatus. Moreover, such conventional turbine vent devices are not sturdy, have limited duration of use, are susceptible of deterioration when exposed to the elements, and require somewhat complicated interconnection procedures. Furthermore, the venting efficiency leaves room for improvement.

Another disadvantage of such turbine vent devices is that they do not provide adequate protection against insects and the weather (i.e. rain and snow) from entering through the device and into the vented area.

These problems with the turbine vent devices have been recognized and attempts have been made to address the various problems through the use of passive roof vents of various shapes, sizes, forms, and features.

However, all of these passive roof vents require the complete replacement of the turbine vent device including the exhaust shaft to which they are mounted, which adds to the expense of replacing these turbine vent devices.

Aside from the turbine roof vents, aging passive pot vents may have been installed begin to look unsightly or may be leaking, and may allow weather to pass through into the building enclosure.

Accordingly, what is desired is a cost effective way for replacing pre-existing turbine roof vent installations, while at the same time overcoming the problems with prior art roof vents. Furthermore, it is also desirable to overcome the problems associated with aging pot vents.

### SUMMARY OF THE INVENTION

The present invention is a roof vent, formed from two components of moulded plastic which has cylindrical collars that are sized and shaped to fit existing twelve inch and fourteen inch diameter exhaust stacks of turbine, or other, roof vents.

According to a first aspect of the present invention the top and bottom components may be coupled together to form a roof vent for use as a cost effective replacement for existing turbine roof vents, while at the same time eliminating or greatly alleviating the problems, disadvantages and complexity common to conventional roof vents.

Therefore, there is disclosed a roof vent comprising:
a top component having a top wall, a side wall, a first louvered region disposed between said top wall and said side wall, and a top cylindrical baffle located inwardly of said first louvered region; and
a bottom component coupled to said top component, said bottom component having at least a first cylindrical collar sized and shaped for mounting to a cylindrical exhaust stack of a first diameter, a second louvered region, a bottom cylindrical baffle sized and positioned relative to said top baffle to form a sinuous flow path for air passing through said vent;
wherein said first louvered region and said second louvered region and said baffles permit the free flow of air through said vent, but inhibit insects and moisture from passing though said vent.

According to a second aspect of the present invention the top component may be used separately, without the bottom component, as a shelter to cover over existing passive pot roof vents that may be leaking or aesthetically unappealing, and to further prevent weather from passing through the pot vent into the building enclosure.

Therefore, there is also disclosed a roof vent as above, wherein said top component may be used separately to cover over an existing passive pot vent.

### BRIEF DESCRIPTION OF THE DRAWINGS

Reference will now be made, by way of example only, to drawings illustrating the preferred embodiments of the invention, in which:

FIG. 1 is a side view of a roof vent of the present invention;

FIG. 2 is a side view of a bottom component of the present invention;

FIG. 3 is a side view of a top component of the present invention;

FIG. 4 is a cross-sectional view of the roof vent of FIG. 1; and

FIG. 5 is a top view of the roof vent of FIG. 1;

FIG. 6 is a perspective view of the roof vent of FIG. 1 mounted on an exhaust stack;

FIG. 7 is a cross-sectional view of another embodiment of the roof vent of FIG. 1, showing the feature of a skirt attached to the top baffle;

FIG. 8 is across-sectional view of the top component of FIG. 3, installed on a roof over top of a passive pot vent; and

FIG. 9 is a side view of a tab connected to a lower edge of the top component of FIG. 3 by a living hinge.

### DETAILED DESCRIPTION OF THE PREFERRED EMBODIMENTS

The present invention is described in more detail with reference to exemplary embodiments thereof as shown in the appended drawings. While the present invention is described below including preferred embodiments, it should be understood that the present invention is not limited thereto. Those of ordinary skill in the art having access to the teachings herein will recognize additional implementations, modifications, and embodiments which are within the scope of the present invention as disclosed and claimed herein. In the figures, like elements are given like reference numbers.

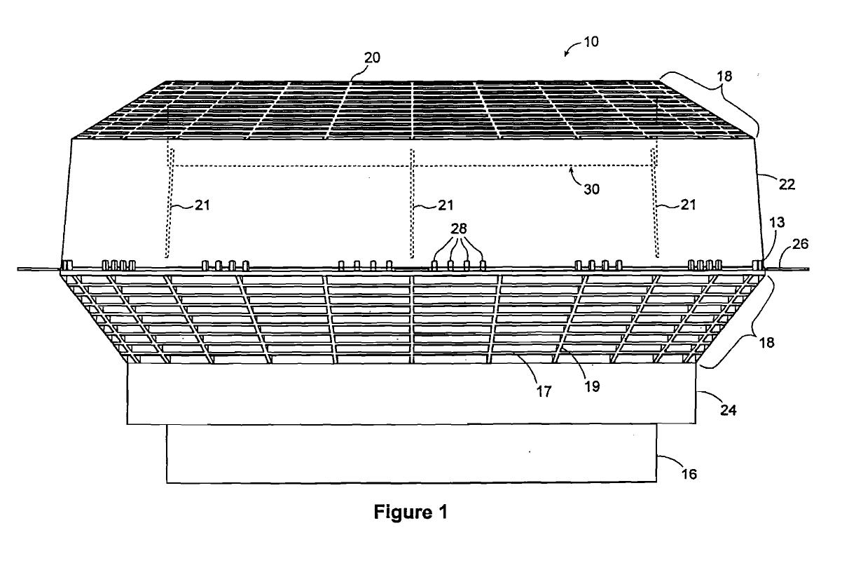

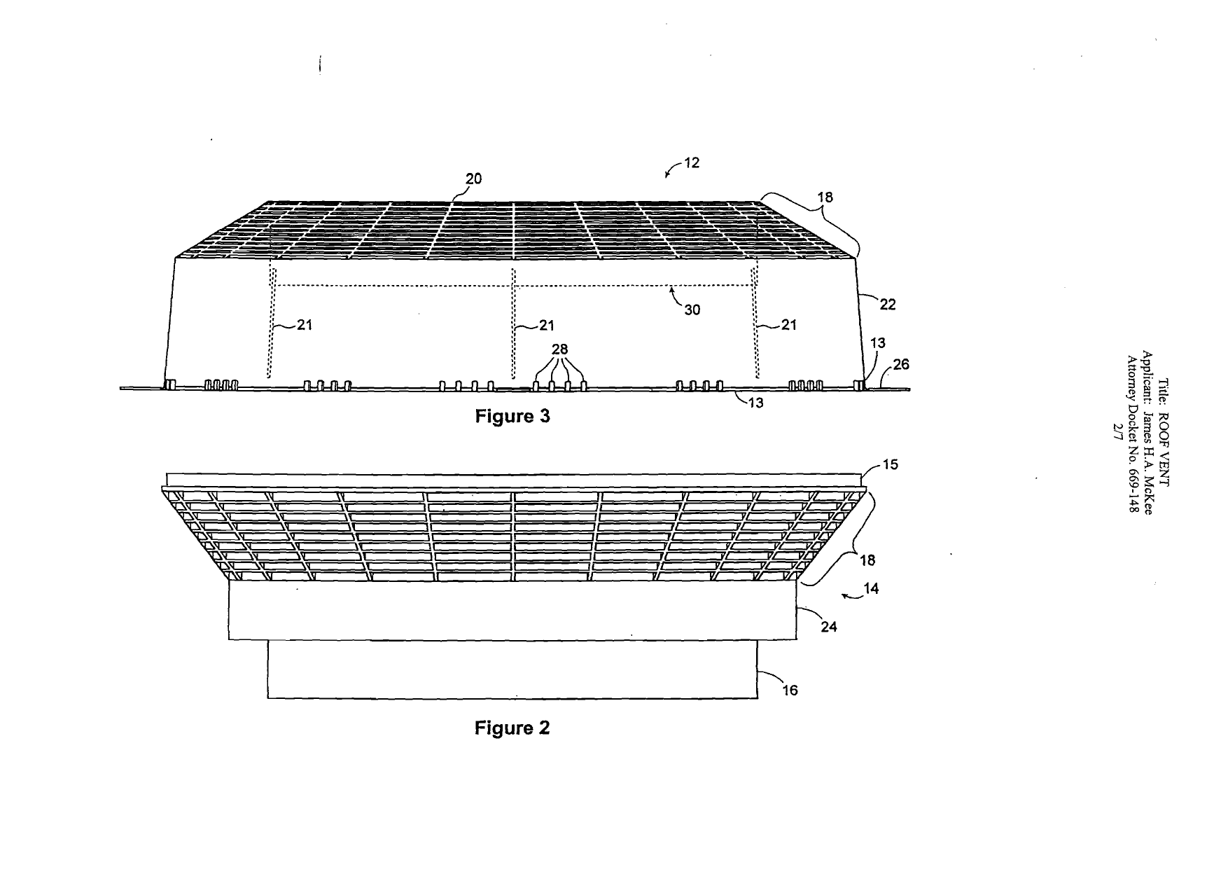

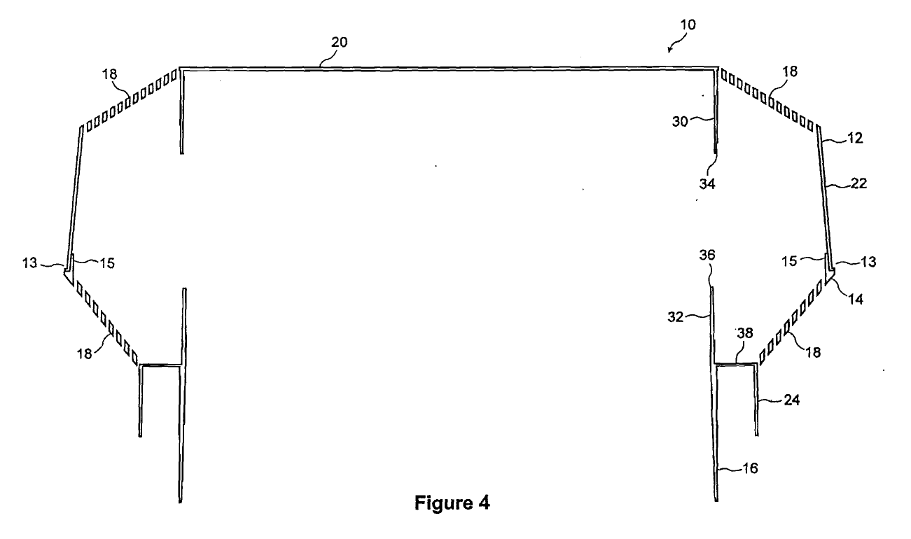

A roof vent 10, according a first aspect of the present invention, is disclosed in FIG. 1. The roof vent 10 comprises a bottom component 14 (see FIG. 2), and a top component 12 (see FIG. 3). As shown in FIG. 4 the top component 12 and bottom component 14 are joined together along the perimeter via a friction fit coupling between a lower edge 13 a side wall 22 of the top component 12 and a complementary lip 15 on the bottom component 14. Both the top component 12 and the bottom component 14 may be formed from molded plastic as is well known in the art. A weather resistant form of plastic having appropriates UV blockers and an aesthetical pleasing colour is preferred.

As shown in FIG. 2, the bottom component 14 includes a first cylindrical collar 16 which preferably has an interior diameter of about 12.1 inches. Most preferably the first cylindrical collar 16 has an internal diameter which gradually decreases from the opening to a narrower diameter at the other end. This taper has two benefits, namely that it makes it easier to mold and secondly it enables the vent to be friction fit onto the exhaust stack. While other anchoring means are also desirable, such as screws or glue or the like, a good friction fit is helpful to add to the stability and integrity of the installation. The bottom component 14 also includes a second cylindrical collar 24 which preferably has an interior diameter of about 14.13 inches. Most preferably the second cylindrical collar 24 has an internal diameter which gradually decreases or tapers from the opening to the other end, in a like manner to that disclosed above for the narrower diameter section. As will be appreciated by those skilled in the art, the first cylindrical collar 16 is preferably provided to fit over a nominal twelve inch diameter exhaust stack 25, while the second cylindrical collar 24 is provided to fit over a nominal fourteen inch diameter exhaust stack 26. Accordingly, the roof vent 10 of the present invention is capable of being mounted to more than one of the commonly used exhaust stack 25 diameters. While more collars could be provided if needed, two is believed sufficient to cover most applications, but two or more such collars are contemplated by the present invention also.

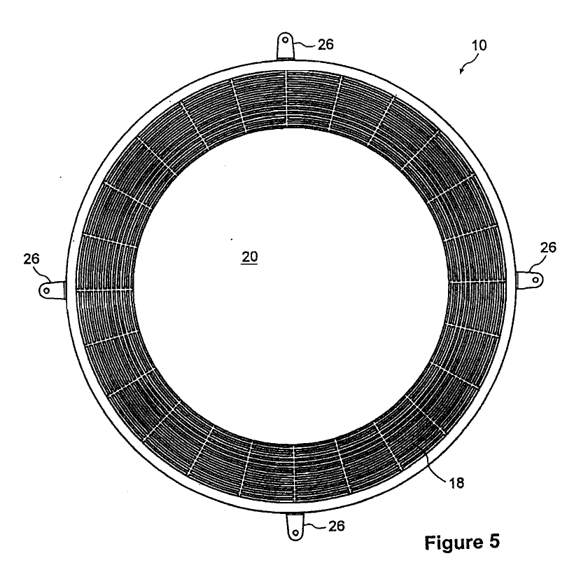

Referring back to FIG. 1, it can be seen that the roof vent 10 has louvered regions 18 on both the top component 12 and the bottom component 14. The individual louvers 17 are supported by ribs 19. The lowered regions 18 are for allowing exhaust air to leave the roof vent 10, and fresh air to enter, while helping to keep rain, snow, moisture and insects out. The louvered regions 18 circumscribe the roof vent 10, as is best seen in FIG. 5, which shows a top view of the roof vent 10. The louvered region 18 of the bottom component 14 expands outwardly from the exhaust stack 25, and the louvered region 18 of the top component 12 expands outwardly from the top 20 of the roof vent 10, to maximize the net free airflow area of the roof vent 10. The spaces between the louvers 17 are most preferably about 0.116 inches, but other spacing is also comprehended. What is important is that the louvered region 18 allows air to pass through into the exhaust stack 25, but helps to keep rain, snow, moisture, and insects out, as described in more detail below. The most preferred form of louver structure is a molded plastic structure for ease of manufacturing and cost, but other materials could also be used.

According to one aspect of the present invention the louvers are in the form of slats which extend in a downwardly direction. The size of each louver is designed to cause any driving precipitation to strike the louver and to so be directed downwardly as it passes through the louvers. Thus, there is less chance of precipitation being able to penetrate past the louvers and into the stack between the two baffles.

As shown in FIGS. 1 and 5, the top 20 and side 22 walls of the top component 12 are solid. Internal support Members 21 may be added to reinforce the side walls 22.

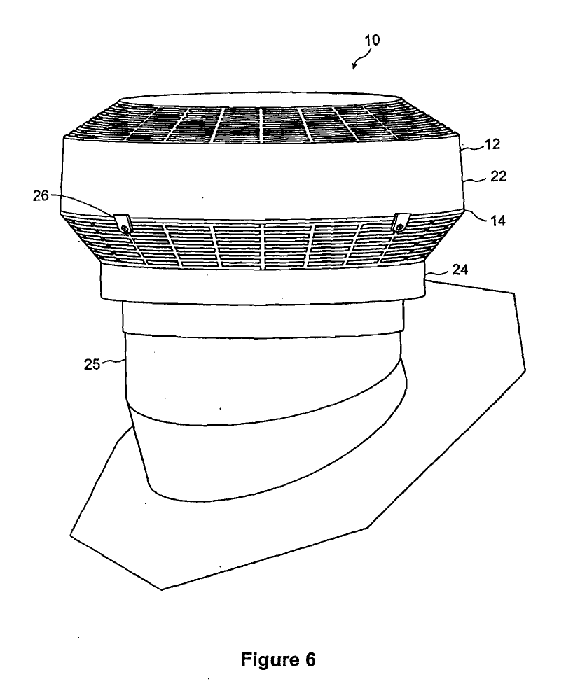

Four tabs 26 extend from a lower edge 13 of the side walls 22 of the top component 12 via living hinges 44 (see FIG. 9). According to the first aspect of the present invention, the tabs 26 are for securing the connection between the top component 12 and the bottom component 14, once the top component 12 and bottom component 24 are connected via the friction fit coupling described above. To this end, the tabs 26 may be provided with a hole for allowing the shank of a threaded fastener to pass therethrough. In this way the tabs 26 may be bent towards the louvered region 18 of the bottom component 14, to lie flat along the surface thereof, and a threaded fastener may be used to secure the tab 26 to the bottom component 14. FIG. 6 shows a roof vent 10 mounted onto an exhaust stack 25, wherein tabs 26 are used to secure the top component 12 to the bottom component 14.

Internally, as seen in FIG. 4, the top component 12 and bottom component 14 together form a baffle system in the roof vent 10 for creating a sinuous or tortuous pathway to inhibit airborne precipitation, such as rain or snow that otherwise passes through the louvered regions 18 from entering into the exhaust stack 25 past the baffles. The baffle system consists of a top cylindrical baffle 30 formed inside of the top component 12, and a bottom cylindrical baffle 32 formed inside the bottom component 14. In the most preferred embodiment of the invention the top cylindrical baffle 30, and bottom cylindrical baffle 32 are spaced apart to allow exhaust air to leave the roof vent 10, and the top cylindrical baffle 30 has a slightly larger diameter than the bottom cylindrical baffle 32 so that its edge 34 hangs past the edge 36 of the bottom cylindrical baffle 32. In this embodiment any precipitation making it past the louvered regions 18 will lie blocked by the baffles before entering the exhaust stack 25 and will collect in a drainage channel 38 which is provided in the bottom component 14 to direct any water that enters through the louvered regions 18 out along the outer surface of the second cylindrical collar 24.

FIG. 6 shows the roof vent 10, according to the first aspect of the present invention, as it would appear mounted on an exhaust stack 25, which is capable of being angled with respect to its base by rotating the top portion of the stack about an angled joint.

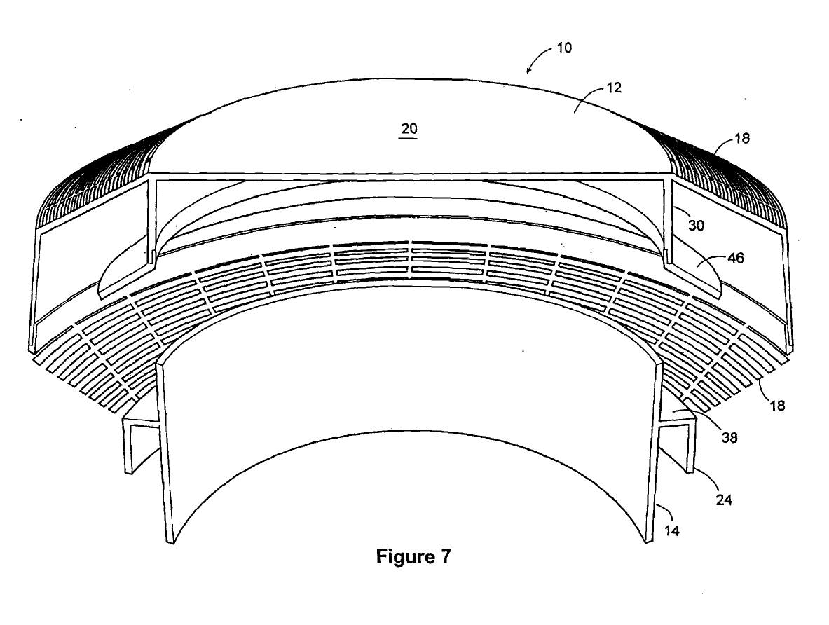

FIG. 7 shows a cross-sectional view of another embodiment of the roof vent 10. In this view there is shown a further feature of a skirt 46 that is attachable to the top cylindrical baffle 30, by a friction fit coupling or the like, to help direct snow and moisture entering through the top louvered region away from the exhaust stack 25, on to the channel 38, and out of the roof vent 10.

As will be appreciated by those skilled in the art, the present invention can be used to replace or instead of turbine vent devices which are commonly installed to either a twelve inch or fourteen inch diameter exhaust stack 25. The combination of a louvered vent region 18 that expands outwardly from the exhaust stack 25, and an internal baffle system, maximizes air flow from a twelve inch or fourteen inch diameter hole, while at the same time helping to limit the amount of weather and insects that enters through the roof vent 10 into the exhaust stack 25.

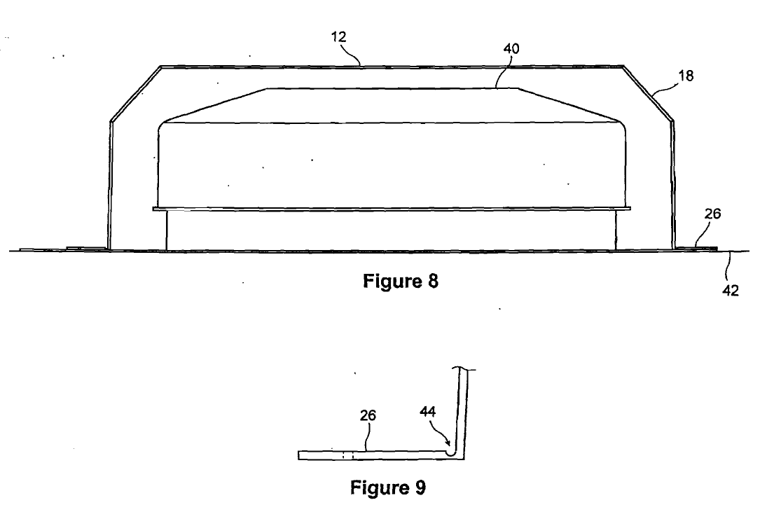

According to a further aspect of the present invention, the top component 12 (shown in FIG. 4) is sized and shaped so it may be used separately as a shelter to cover over existing passive pot vents that may be leaking or unsightly. As shown in FIG. 8 the top component 12 may be installed over a passive pot vent 40 on a roof 42. The top component 12 is secured to the roof 42 via tabs 26 located at the lower edge 13 of the top component 12. The tabs 26 are attached to the top component 12 via living hinges 44, as shown in FIG. 9, to allow the tab 26 to adjust to the roof surface 42. The living hinges 44 of the tabs 26 also allow the top component 12 to be packaged in a smaller box by folding the tabs down to take up less space. It can now be understood that the diameter of the top baffle must be large enough to accommodate a pot vent within the diameter. Thus, this is another reason it is preferred to make the top baffle outside of the bottom baffle as explained above and as shown in the drawings.

When installed, as shown in FIG. 8, the top component 12 allows air to be exhausted through the louvered region 18, while allowing fresh air to replace the exhausted stale air. As described above the baffles create a sinuous or tortuous path for precipitation and snow, in order to help inhibit moisture from entering into the exhaust stack 25. Furthermore, by completely covering the passive pot vent 40 it can turn an aging installation into an aesthetically pleasing one. Any precipitation that does make it past the louvered region 18 will first strike the top baffle and if it can get past the top baffle will likely encounter to top of the covered up pot vent. It is unlikely that any moisture will get past both the vent cover and the old vent, and the water that is stopped and collected is caused to drain outside through a plurality of water drains 28 which are disposed along the lower edge 13 of the top component 12, as shown in FIG. 3. It should be noted that these water drains 28 are covered by the lip 15 on the bottom component 14 when the top component 12 and bottom component 14 are coupled together to form the roof vent 10 as described above with respect to the first aspect of the present invention.

When the top component 12 is used to shelter a passive pot vent 40, as described above, the top cylindrical baffle 30 of the baffle system may be removed or left in place. It is believed to be preferred to leave it in place, again to help prevent moisture from penetrating through the vent. The top cylindrical baffle 30 is therefore sized and shaped so that when the top component 12 is placed on a planar surface, a gap exists between the lower edge of the top cylindrical baffle 30 and the top of the planar surface. In comparison, since the bottom component 14 does not have to match a planar surface and in light of the desired to create, between the two baffles, a sinuous path the bottom cylindrical baffle 32 the present invention comprehends that the lower louver may extend above the height of the top outer edge of the lower portion. In this way the edge 36 of the bottom cylindrical baffle 32 is can above the edge 34 of the top cylindrical baffle 30 in the assembled position, but only if it is spaced inwardly enough to provide a free air flow path. Thus, the most preferred form of the invention as shown in the drawings has the lower baffle spaced slightly inwardly of the upper baffle, and there being no vertical overlap between the two. The angle of slats of the louvers is used to direct the air flow, and thus precipitation, away from the opening between the upper and lower baffles. Also, the removable collar assists in this regard. As will be understood by those skilled in the art, the degree of vertical overlap between the baffles can be varied, and it is not be necessary to have any vertical overlap due to the horizontal spacing between the baffles. What is desired is to have a baffle structure which broadly inhibits the inflow of moisture into the vent, and corresponding structures in the body of the vent to control and drain away any such moisture so inhibited.

As can be appreciated from the above description, the top component 12 may be used separately from the bottom component 14 as a shelter to cover aging passive pot vents to stop snow and rain from entering and for providing an aesthetics to the vent 40. According to the present invention this improved performance can be achieved without the need to remove the old vent, thus saving time and effort and expense. In one simple step the old leaky vent can be covered and the combination of the old vent and the cover can be much more successful at inhibiting moisture inflow than was the old vent before. A further advantage is that it prevents staining on the roof by changing exhaust air to a chimney effect.

While reference has been made to various preferred embodiments of the invention other variations are comprehended by the broad scope of the appended claims. Some of these have been discussed in detail in this specification and others will be apparent to those skilled in the art. All such variations and alterations are comprehended by this specification are intended to be covered, without limitation.

1-15. (canceled)

16. A top component for a roof vent structure, said top component comprising:
a continuous upstanding side wall having a top edge and a bottom edge;
a louvered section attached to the top edge having louvers sized and shaped to direct water substantially downwardly;
an impervious top section extending from a top edge of the louvered section;
drainage openings formed in said lower edge of said upstanding wall; and
one or more attachment tabs extending from said lower edge of said upstanding wall and being attached to said lower edge by means of a living hinge to permit said tabs to be bent outwardly to permit said top component to be attached to a roof surface over an existing vent.

17. The top component as claimed in claim 16, wherein said continuous upstanding side wall forms a circle in top view.

18. The top component as claimed in claim 17, further including a baffle extending downwardly from said top section inwardly of said louvered section.

19. The top component as claimed in claim 18, wherein said baffle is removably attached to said top section.

20. The top component as claimed in claim 19, wherein said baffle extends below said top section by an amount less than the height of the upstanding side walls.

21. The top component as claimed in claim 16, made from molded plastic.

22. The top component as claimed in claim 16, wherein said drainage openings are formed only in one half of said lower edge, said one half defining a lower portion to be positioned on said roof below the other half of said lower edge.

23. The top component as claimed in claim 22, wherein said drainage openings take the form of a plurality of openings formed along said lower half portion of said lower edge.

24. The top component as claimed in claim 16, wherein said louvered portion is spaced above said roof surface to prevent staining of said roof surface by air exhausted from said louvers.

25. The top component as claimed in claim 16, wherein said top section is generally planar.

26. The top component as claimed in claim 16, wherein said component includes four attachment tabs.

27. A top component for a roof vent structure, said top component comprising:
a continuous upstanding side wall having a top edge and a bottom edge;
an inclined louvered section attached to the top edge and extending inwardly and upwardly from said top edge, said louvered section having louvers sized and shaped to direct water substantially downwardly, while permitting air to pass therebetween;
an impervious top section extending from an upper inward edge of said louvered section;
drainage openings formed in said lower edge of said upstanding wall; and
attachment tabs extending from said lower edge of said upstanding wall and being attached to said lower edge by means of a living hinge to permit said tabs to be extended outwardly to permit said top component to be attached to a roof surface, said continuous upstanding side wall, louvered section and top section defining an internal space which is sized and shaped to permit said top component to be placed over an existing vent when attached to said roof surface.

28. A method of covering an existing roof vent with a top component having
a continuous upstanding side wall having a top edge and a bottom edge;
an inclined louvered section attached to the top edge and extending inwardly and upwardly from said top edge, said louvered section having louvers sized and shaped to direct water substantially downwardly, while permitting air to pass therebetween: an impervious top section extending from an upper inward edge of said louvered section; a plurality of drainage openings formed in said lower edge of said upstanding wall; and attachment tabs extending from said lower edge of said upstanding wall and being attached to said lower edge by means of a living hinge, said method comprising the steps of:
bending the attachment tabs outwardly away from said lower edge of said continuous upstanding side walls at said living hinge;
placing said top component over said existing roof vent on said roof; and
using fasteners to attach said attachment tabs to said roof to secure said top component over said existing vent.

29. The method of claim 28, wherein said roof is sloped, said method further including the step of positioning said top component so that the drainage openings are on a lower part of said top component when said top component is attached to said roof
